(19) United States
(12) Patent Application Publication
(10) Pub. No.: US 2011/0113351 A1
(43) Pub. Date: May 12, 2011

(54) CONTEXT RESTORATION VIA SAVED HISTORY WHEN REJOINING A MULTI-USER ENVIRONMENT

(75) Inventor: Christopher Phillips, Chandlers Ford (GB)

(73) Assignee: INTERNATIONAL BUSINESS MACHINES CORPORATION, Armonk, NY (US)

(21) Appl. No.: 12/615,168

(22) Filed: Nov. 9, 2009

(51) Int. Cl. G06F 3/048; G06F 15/16

(52) U.S. Cl. 715/757; 715/753

(57) ABSTRACT

Embodiments of the present invention provide a method, system and computer program product for context restoration via saved history when rejoining a meeting in a multi-user environment. In an embodiment of the invention, a method for context restoration via saved history when rejoining a meeting in a multi-user environment can include displaying a contemporary view of a meeting in a multi-user environment hosted in memory of a computer, detecting an inactive participant to the meeting, subsequently detecting a rejoining of the inactive participant to the meeting, and additionally displaying concurrently with the contemporary view, a playback view of a portion of the meeting computed when the participant had been inactive.

### BACKGROUND OF THE INVENTION

1. Field of the Invention

The present invention relates to the multi-user environments including virtual worlds, and more particularly to avatar-to-avatar interactions in a virtual world.

2. Description of the Related Art

As the progenitor to the modern virtual world, the multi-user dungeon provided a revolutionary experience for its first participants more than three decades ago. The multi-user dungeon was and continues to be a multi-player computer game that combines elements of role-playing, first person shooter and social chat. The multi-user dungeon generally executes in a central server configured for simultaneous access by participants over a global computer communications network like the Internet. The multi-user dungeon historically has been text-driven where the immediate environment is presented to participants in text form, and participants engage in actions in the environment through textual directives mimicking the postings of an instant messenger. Non-player characters in the multi-user dungeon can be automated and the actions of the non-player characters can be broadcast to the participants also as textual postings.

Like a multi-user dungeon, virtual reality allows a user to interact with a computer-simulated environment; however in virtual reality, the virtual environment is visual in nature and can be displayed either on a computer screen or through customized or stereoscopic displays. Advanced modes of virtual reality further incorporate other sensory presentation elements, including audio elements and tactile elements. Generally, end-users interact with a virtual reality environment through traditional keyboard and mouse movements, though other input means are provided occasionally including gyroscopic handheld devices and gloves, and joysticks. Consistent throughout all virtual reality experiences, the virtual reality environment reflects the real world environment and has proven invaluable in commercial applications such as flight simulation or combat training.

The virtual world builds upon the multi-user dungeon and virtual reality in order to provide a computer-based simulated environment in which participants interact with one another through three-dimensional visually displayable surrogates referred to as avatars. In this regard, participants “inhabit” the virtual world through their respective avatars. In as much as avatars can freely roam the bounds of the virtual world, virtual worlds expand the boundaries of the multi-user dungeon and permit participants to truly enjoy freedom of motion and exploration within the virtual world. To date, virtual worlds have become such close approximations to reality that the lines of reality have become blurred to the extent that many participants treat ordinary interactions in the virtual world with the same degree of seriousness as those same interactions in the real world.

Avatar-to-avatar interactions in a virtual world expand upon the basic notion of a chat room or instant messaging session in which users take “turns” in providing conversational input—generally text messages into a common view—the chat transcript. Of course, as in the case of all things in the virtual world, interactions between avatars in the virtual world can be substantially more life like in that visual representations of the chat participants—the avatars—can “meet” in a virtual place in which a meeting is to occur and through which turns can be taken amongst the participating avatars to the meeting. Nevertheless, as in the case of a chat session, context can be of paramount importance to the effectiveness of chat session.

In this regard, as different participants to a virtual meeting enter the virtual space in which the meeting occurs, the context of the meeting is the historical aggregation of postings by the different avatars to the meeting. Likewise, in a chat session, the context of the chat session is the historical aggregation of text input by the different participants to the chat session. To ensure that a newly added participant to a chat session recognizes the current context of the chat session, many chat clients permit the insertion of the transcript of the chat session to date into the chat client of the newly added participant. In this way, a quick review of the transcript permits the newly added participant to recognize the context of the chat session. In the virtual world environment, however, there is no such transcript given the lifelike nature of the meeting. Thus, merely presenting a chat transcript in a virtual world is not a suitable solution to the problem of presenting context to avatars entering a virtual meeting.

### BRIEF SUMMARY OF THE INVENTION

Embodiments of the present invention address deficiencies of the art in respect to context management for meetings in a virtual world and provide a novel and non-obvious method, system and computer program product for context restoration via saved history when rejoining a meeting in a multi-user environment. In an embodiment of the invention, a method for context restoration via saved history when rejoining a meeting in a multi-user environment can include displaying a contemporary view of a meeting in a multi-user environment hosted in memory of a computer, detecting an inactive participant to the meeting, subsequently detecting a rejoining of the inactive participant to the meeting, and additionally displaying concurrently with the contemporary view, a playback view of a portion of the meeting computed when the participant had been inactive.

In one aspect of the embodiment, the multi-user environment is a virtual world hosted by a virtual world server executing in the memory of the computer. In another aspect of the embodiment, the method further includes visually distinguishing an avatar for the inactive participant to the meeting for a duration of time when the inactive participant is inactive. In yet another aspect of the embodiment, the additional display of the playback view can include computing a portion of the meeting when the participant had been inactive by retrieving a timestamp from a flag established when the participant is detected to have become inactive, and a time when the participant is determined to have rejoined the meeting, retrieving from a data store a recorded portion of the meeting corresponding to the computed portion, and playing back the recorded portion of the meeting in a display of a playback view concurrently with a real-time display of the meeting in the contemporary view.

In another embodiment of the invention, a virtual world data processing system can be configured for context restoration via saved history when rejoining a meeting in a virtual world. The system can include a host server with processor and memory and a virtual world server executing in the memory of the host server by the processor of the host server. The virtual world server can provide a virtual world utilized by participants communicatively coupled to the host server over a computer communications network through respective virtual world clients. The system also can include a meeting recording data store storing a recorded meeting amongst the participants. Finally, the system can include a context restore module coupled to the virtual world server.

The context restore module can include program code enabled to detect an inactive participant to the meeting, subsequently detect a rejoining of the inactive participant to the meeting, and additionally displaying concurrently with a contemporary view of the meeting in real-time as provided by the virtual world server, a playback view of a portion of the meeting previously recorded and stored in the meeting recording data store, the portion being computed for when the participant had been inactive.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a user interface to a virtual world supporting context restoration via saved history when rejoining a meeting in the virtual world;

FIG. 2 is a schematic illustration of a virtual world data processing system configured for context restoration via saved history when rejoining a meeting; and,

FIG. 3 is a flow chart illustrating a process for context restoration via saved history when rejoining a meeting in a virtual world.

### DETAILED DESCRIPTION OF THE INVENTION

Embodiments of the invention provide for context restoration via saved history when rejoining a meeting in the virtual world. In accordance with an embodiment of the invention, a meeting in a virtual world amongst different participants can be recorded and the participants to the meeting can be monitored for inactivity. Upon detecting an inactive participant, a timestamp can be recorded for the inactive participant. In response to the inactive participant rejoining the meeting, a portion of the recording can be replayed from the time of the timestamp concurrently with a display of the meeting in a user interface to the virtual world. In this way, the context of the meeting can be provided to the participant rejoining the meeting despite the detected period of inactivity.

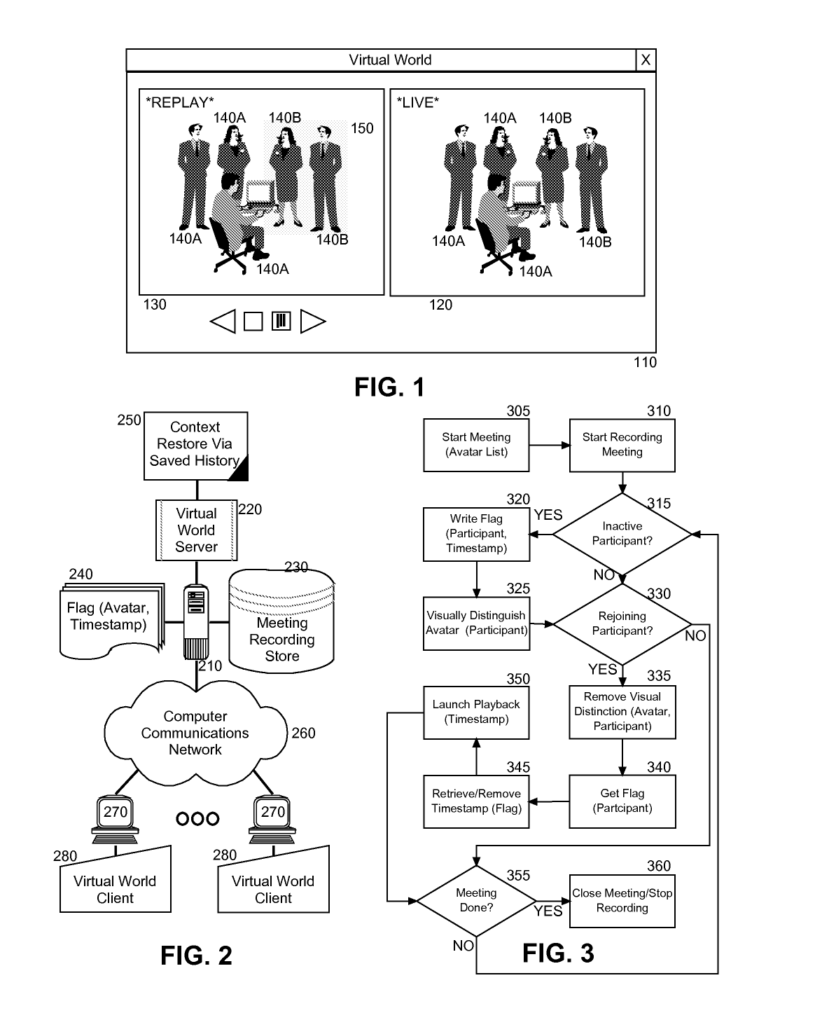

In illustration, FIG. 1 pictorially depicts an exemplary, simplified user interface to a virtual world supporting context restoration via saved history when rejoining a meeting in the virtual world. As shown in FIG. 1, a user interface 110 to a virtual world can be provided. The user interface 110 can present a real-time view 120 of a meeting in progress in which different avatars 140A, 140B for corresponding participants to the meeting participate. A period of inactivity can be detected for one of more of the participants in the course of the meeting. During the period of inactivity, a distinguishing visual characteristic 150 can be applied to the avatars 140B for the inactive participants such that the other participants remaining active in the meeting can recognize the inactive nature of the inactive participants.

Upon the inactive participants rejoining the meeting, the distinguishing visual characteristic 150 can be removed from the real-time view 120; however, a replay view 130 of the meeting for a time period during which the participants had been inactive can be presented concurrently with the real-time view 120 in the user interface 110 for each of the previously inactive participants. Consequently, the previously inactive participants can view the missed portion of the meeting while viewing the progress of the meeting in real-time so as to resolve lost context resulting from the period of inactivity.

The process described in connection with FIG. 1 can be implemented with a virtual world data processing system. In further illustration, FIG. 2 is a schematic illustration of a virtual world data processing system configured for context restoration via saved history when rejoining a meeting. The system can include a host server 210 with processor and memory supporting the execution in the memory by the processor of a virtual world server 220. The virtual world server 220 can be configured for communicative coupling over a computer communications network 260 to different client computing devices 270, each supporting a virtual world client 280 through which end user participants can be participate in real-time interactions hosted by the virtual world server 220.

Of note, context restore module 250 can be coupled to the virtual world server 220. The context restore module 250 can include program code executable by the processor of the host server 210 when loaded into the memory of the host server 210 so as to provide context restoration via saved history for participants rejoining a meeting hosted by the virtual world server 220. In this regard, the context restore module 250 can be enabled to record a meeting hosted by the virtual world server 220 in a meeting recording store 230. The recorded meeting can include, by way of example, a frame-by-frame persistence of the interactions of different avatars meeting including posted turns of conversation and movements of the avatar with respect to one another.

The context restore module 250 further can be enabled to detect inactivity amongst any of the participants to the meeting. In response to detecting inactivity for a participant to the meeting, the context restore module 250 can write a flag 240 noting the avatar for the participant and a timestamp when the participant had been detected inactive. Subsequently, upon detecting the participant rejoining the meeting following a period of inactivity, the context restore module 250 can retrieve the flag 240 for the participant in order to compute the elapsed time with reference to the timestamp during which the participant had been inactive. Thereafter, the context restore module 250 can retrieve from the meeting recording store 230 and playback for the participant a portion of the meeting corresponding to the elapsed time. Additionally, the playback can occur concurrently with the display of a real-time view of the meeting.

In even yet further illustration, FIG. 3 is a flow chart illustrating a process for context restoration via saved history when rejoining a meeting in a virtual world. Beginning in block 305, a meeting can be initiated amongst different participants in a multi-user environment such as a virtual world. In the case of a virtual world, each participant can be visually represented by an avatar and a list of avatars participating in the meeting can be maintained by the virtual world. In block 310, the meeting can be recorded. For example, the meeting can be recorded in the virtual world server hosting the virtual world on a frame by frame basis or any interval thereof. Alternatively, the meeting can be recorded by each virtual world client on a frame by frame basis or any interval thereof.

In block 315, inactivity can be detected amongst the participants to the meeting. For example an inactive participant to the meeting can be detected by way of a lack of participation in the meeting for a threshold period of time. In block 320, in response to detecting inactivity for a particular participant to the meeting visually represented by a corresponding avatar, a flag can be written noting both the avatar and a timestamp indicating a time when the participant had become inactive. Additionally, in block 325 the avatar corresponding to the inactive participant can be visually distinguished to indicate the inactivity of the participant to other participants to the meeting. For example, the avatar can be grayed out or rendered semi-transparent.

In decision block 330, it can be determined whether or not a previously inactive participant has reconnected to the meeting and become active in consequence. If so, in block 335, the visually distinguishing characteristic of a corresponding avatar can be removed to indicate the active nature of the participant and in block 340, the flag for the participant can be retrieved. In block 345, a timestamp in the flag can be extracted and used to determine a segment of the recorded meeting to be played back to the participant in order to provide the relevant context of the meeting lost upon the participant due to the prior period of inactivity. As such, in block 350, a playback view of that computed portion of the meeting can be played back in a separate window concurrently with the visual display of the contemporaneously occurring meeting.

In decision block 355, it can be determined whether or not the meeting has concluded. If not, the process can return to decision block 315 and the process can repeat again. Otherwise, in block 360, the meeting can be closed and the recording of the meeting can discontinue.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for context restoration via saved history when rejoining a meeting in a multi-user environment, the method comprising:
displaying a contemporary view of a meeting in a multi-user environment hosted in memory of a computer;
detecting an inactive participant to the meeting;
subsequently detecting a rejoining of the inactive participant to the meeting; and,
additionally displaying concurrently with the contemporary view, a playback view of a portion of the meeting computed when the participant had been inactive.

2. The method of claim 1, wherein the multi-user environment is a virtual world hosted by a virtual world server executing in the memory of the computer.

3. The method of claim 2, further comprising:
visually distinguishing an avatar for the inactive participant to the meeting for a duration of time when the inactive participant is inactive.

4. The method of claim 1, wherein additionally displaying concurrently with the contemporary view, a playback view of a portion of the meeting computed when the participant had been inactive, comprises:
computing a portion of the meeting when the participant had been inactive by retrieving a timestamp from a flag established when the participant is detected to have become inactive, and a time when the participant is determined to have rejoined the meeting;
retrieving from a data store a recorded portion of the meeting corresponding to the computed portion; and,
playing back the recorded portion of the meeting in a display of a playback view concurrently with a real-time display of the meeting in the contemporary view.

5. A virtual world data processing system configured for context restoration via saved history when rejoining a meeting in a virtual world, the system comprising:
a host server with processor and memory;
a virtual world server executing in the memory of the host server by the processor of the host server and providing a virtual world utilized by participants communicatively coupled to the host server over a computer communications network through respective virtual world clients;
a meeting recording data store storing a recorded meeting amongst the participants; and,
a context restore module coupled to the virtual world server, the module comprising program code enabled to detect an inactive participant to the meeting, subsequently detect a rejoining of the inactive participant to the meeting, and additionally displaying concurrently with a contemporary view of the meeting in real-time as provided by the virtual world server, a playback view of a portion of the meeting previously recorded and stored in the meeting recording data store, the portion being computed for when the participant had been inactive.

6. A computer program product comprising a computer usable medium embodying computer usable program code for context restoration via saved history when rejoining a meeting in a multi-user environment, the computer program product comprising:
computer usable program code for displaying a contemporary view of a meeting in a multi-user environment hosted in memory of a computer;
computer usable program code for detecting an inactive participant to the meeting;
computer usable program code for subsequently detecting a rejoining of the inactive participant to the meeting; and,
computer usable program code for additionally displaying concurrently with the contemporary view, a playback view of a portion of the meeting computed when the participant had been inactive.

7. The computer program product of claim 6, wherein the multi-user environment is a virtual world hosted by a virtual world server executing in the memory of the computer.

8. The computer program product of claim 7, further comprising:
computer usable program code for visually distinguishing an avatar for the inactive participant to the meeting for a duration of time when the inactive participant is inactive.

9. The computer program product of claim 6, wherein the computer usable program code for additionally displaying concurrently with the contemporary view, a playback view of a portion of the meeting computed when the participant had been inactive, comprises:
computer usable program code for computing a portion of the meeting when the participant had been inactive by retrieving a timestamp from a flag established when the participant is detected to have become inactive, and a time when the participant is determined to have rejoined the meeting;
computer usable program code for retrieving from a data store a recorded portion of the meeting corresponding to the computed portion; and,
computer usable program code for playing back the recorded portion of the meeting in a display of a playback view concurrently with a real-time display of the meeting in the contemporary view.
